(19) United States
(12) Patent Application Publication
(10) Pub. No.: US 2025/0187647 A1
(43) Pub. Date: Jun. 12, 2025

(54) STEERING WHEEL ARRANGEMENT, VEHICLE HAVING THE STEERING WHEEL ARRANGEMENT, AND METHOD FOR VERIFYING A SKELETON CONNECTION IN THE STEERING WHEEL ARRANGEMENT

(71) Applicant: ZF AUTOMOTIVE GERMANY GMBH, Alfdorf (DE)

(72) Inventor: Johann SCHMID, Neubeuern (DE)

(21) Appl. No.: 18/844,968

(22) PCT Filed: Feb. 23, 2023
(86) PCT No.: PCT/EP2023/054514

§ 371 Date: Sep. 8, 2024

(30) Foreign Application Priority Data
Mar. 9, 2022 (DE) 10 2022 105 491.8

(51) Int. Cl. B62D 1/04; B62D 1/06; G01V 3/08

(52) U.S. Cl. CPC B62D 1/046; B62D 1/06; G01V 3/088

(57) ABSTRACT

The invention relates to a steering wheel arrangement 1 for a vehicle comprising a steering wheel device 2, wherein: the steering wheel device 2 has a steering wheel skeleton 3, a first conductive layer 6 and a second conductive layer 8; an inter-layer capacitor C_Layer_12 is formed between the first conductive layer 6 and the second conductive layer 8; a skeleton capacitor C_Skeleton is formed between the second conductive layer 8 and the steering wheel skeleton 3; the steering wheel skeleton 3 can be and/or is coupled to an earth M of the vehicle via a skeleton connection 13; the inter-layer capacitor C_Layer_12 and the skeleton capacitor C_Skeleton form a capacitive voltage divider for a voltage present at the first conductive layer 6; and a partial voltage can be sensed at the second conductive layer 8. The steering wheel arrangement also comprises an evaluation device 16, wherein the evaluation device 16 is designed to detect the partial voltage at the second conductive layer 8 and, on the basis of the detected partial voltage, assess the skeleton connection 13 to be OK, or not OK.

The invention relates to a steering wheel arrangement, a vehicle comprising the steering wheel arrangement, and a method for verifying a skeleton connection of the steering wheel arrangement.

In semi-autonomous or fully autonomous driving, the monitoring whether a driver is holding a steering wheel with their hand or whether the driver is leaving the steering wheel unattended is important for the driving safety.

Hands-on detection/HOD systems have been installed in many cases and frequently are based on a capacitance measurement of a capacitance of the steering wheel that is changed by at least one hand being placed on the steering wheel.

The document DE 102014223128 A1 that constitutes the closest prior art discloses a steering wheel having a sensor structure for hands-on recognition of a heated contact surface, comprising: a contact surface which forms at least a part of the outer layer of the steering wheel; a steering wheel skeleton; a sensor portion in which at least one sensor electrode for hands-on recognition and at least one heating wire are arranged; and a potential layer arranged between the sensor heating layer and the steering wheel skeleton, wherein a defined potential can be applied to the potential layer.

It is an object of the invention to suggest a steering wheel arrangement the status of which can be verified in an easy and inexpensive manner. This object is achieved by a steering wheel arrangement comprising the features of claim 1, by a vehicle comprising the features of claim 10 and by a method for verifying a skeleton connection comprising the features of claim 11. Advantageous or preferred embodiments of the invention result from the subclaims, the following description and the figures.

The subject of the invention is a steering wheel arrangement which is suitable and/or designed for a vehicle. The vehicle can be a passenger car, a truck, but also a bicycle, tricycle, two-wheeler, etc.

The steering wheel arrangement has a steering wheel device, wherein the steering wheel device can preferably comprise a particularly round steering wheel rim—also referred to as steering wheel ring. However, it is also possible that the steering wheel device is reduced to two handle areas and/or is designed like a horizontal eight. It is further possible that the steering wheel device is designed as a handlebar having two handlebar ends or horns. In particular, the steering wheel device is a human-machine interface through which a driver of the vehicle mechanically transfers a steering instruction to the vehicle.

The steering wheel device includes a steering wheel skeleton. The steering wheel skeleton is preferably made of a metallic material. For example, the steering wheel skeleton is manufactured of an aluminum alloy and/or of a magnesium alloy. The steering wheel skeleton includes, for example, the steering wheel rim which is connected to a hub via spokes. The steering wheel rim, the spokes and the hub jointly form the steering wheel skeleton.

Furthermore, the steering wheel device has a first conductive layer and a second conductive layer. Each of the conductive layers forms at least one conductive conductor portion. The conductive conductor portion can be designed as a single wire, a grid of wires or the like. Particularly preferred, the conductive conductor portion is integrated in a handle area of the steering wheel device. For example, the conductive conductor portion includes a metallic wire. Preferably, the first conductive layer, the second conductive layer and the steering wheel skeleton are arranged concentrically and/or in cross-section layered relative to each other, the second conductive layer being arranged between the first conductive layer and the steering wheel skeleton particularly in a handle area of the steering wheel skeleton and/or at the rim of the steering wheel skeleton.

An inter-layer capacitance is formed between the first conductive layer and the second conductive layer. In particular, the first conductive layer and the second conductive layer form an inter-layer capacitor.

A skeleton capacitance is formed between the second conductive layer and the steering wheel skeleton. In particular, the second conductive layer and the steering wheel skeleton form or at least are involved in forming a skeleton capacitor.

The steering wheel skeleton is coupled to an earth of the vehicle via a skeleton connection. On the one hand, it is possible that the skeleton connection is and/or can be galvanically connected to the earth of the vehicle. As an alternative, a connection capacitance, specifically designed as a connection capacitor, is arranged in the skeleton connection to the earth of the vehicle. Preferably, the connection capacitor is at least 10 times higher than the inter-layer capacitor or the skeleton capacitor. In view of design, the skeleton connection preferably has a cable portion, wherein the cable portion is connected to the steering wheel arrangement and can be and/or is connected to the vehicle. Where necessary, the earth capacitance is arranged serially in, upstream or downstream of the cable portion and/or is particularly preferably designed as a capacitor component or capacitor component group.

The inter-layer capacitor and the skeleton capacitor jointly form a capacitive voltage divider for a voltage present at the first conductive layer. Due to the capacitive voltage division, a partial voltage, particularly of the voltage present at the first conductive layer, is present at the second conductive layer so that it can be sensed. The second conductive layer forms in particular a center tap at the capacitive voltage divider.

Within the scope of the invention, the steering wheel arrangement is suggested to include an evaluation device. In particular, the evaluation device is designed as a digital data processing device. Optionally, the evaluation device can also have analogous components. As an alternative, the evaluation device is realized as an analogous circuit.

The evaluation device is designed, particularly in terms of programming and/or circuitry, to detect the partial voltage and, on the basis of the sensed partial voltage, to assess the skeleton connection to be OK or not OK. The partial voltage can be a voltage value, e.g. in volt. Alternatively, the partial voltage is an analogous or digital reference value relative to the voltage value. The skeleton connection can also be coupled to the earth of the vehicle via the evaluation device.

The assessment can be output as a control signal to a monitoring unit for further processing and/or can be displayed as a light signal to the driver.

Accordingly, it is a consideration of the invention that the basic constructional design of such a steering wheel arrangement already has all components of a capacitive voltage divider. Further, it was recognized in the invention that, if the skeleton connection is defective, the voltage conditions in the capacitive voltage divider vary so strongly that such defect can be reliably recognized easily by verifying the partial voltage, or a reference variable that is based on the partial voltage.

It is a further consideration of the invention that common hands-on detection devices work on a capacitive basis, the capacitance depending on the steering wheel skeleton coupled to earth. If the skeleton connection is defective or is not present e.g. due to faulty assembly, also the hands-on detection cannot or at least not reliably be carried out via the hands-on detection device. The status of the steering wheel arrangement is verified safely and inexpensively with respect to the skeleton connection by the steering wheel arrangement according to the invention without, or at least only with a low, additional hardware effort.

In a preferred configuration of the invention, the steering wheel arrangement includes a control device. The control device is designed particularly as a digital data processing unit. Alternatively, the control device can also have analogous components. As an alternative, the control device is designed as an analogous circuit. The control device is designed, in particular in terms of programming and/or circuitry, to bring, in a first phase, the first conductive layer and the second conductive layer into a respective defined first voltage state. In doing so, the first voltage state can be provided to be designed differently for the two conductive layers. However, the voltage state is preferred to be designed identically for the two conductive states.

The control device further is designed, in particular in terms of programming and/or circuitry, to decouple, in a second phase, the second conductive phase, particularly to set it to high impedance, specifically such that a floating potential is resulting in the first conductive layer, and to bring the first conductive layer into a second voltage state, the second voltage state being designed to be different from the first voltage state. The evaluation device is designed, in particular in terms of programming and/or circuitry, to measure the partial voltage in the second phase.

Thus, in the first phase, the two conductive layers are set to a defined potential. In the second phase, the first conductive layer is decoupled and/or set to high impedance, specifically such that a floating potential is resulting in the first conductive layer, and the second conductive layer is brought to a different potential. By the arrangement as a capacitive voltage divider, the partial voltage in the second conductive layer varies depending on the capacitors present. In particular the skeleton capacitor is designed differently for a defective skeleton connection and a functioning skeleton connection so that, on the basis of the measured partial voltage, the skeleton connection can be assessed to be OK or not OK.

In a possible configuration of the invention, in the first voltage state the first and/or the second conductive layer is/are grounded. In the second voltage state and/or in the second phase, a d.c. voltage is present at the first conductive layer. Preferably, the second conductive layer is electrically insulated. This dynamic change of the voltage states helps achieve a variation of the partial voltage which can be detected by measuring by the evaluation device.

In an alternative configuration of the invention, the first voltage state corresponds to a d.c. voltage, wherein after disconnecting the second conductive layer and after setting to high impedance, the second voltage state of the first conductive layer corresponds to a different d.c. voltage or to an earth. In this process sequence, too, a defect of the skeleton connection can be safely detected via the partial voltage.

The partial voltage can be assessed with respect to the status of the skeleton connection (OK/not OK) by comparing the partial voltage to a stored, specifically predetermined or learnt, reference value, for example.

Optionally, the steering wheel arrangement has an ambience capacitor, the ambience capacitor being formed between the first conductive layer and the steering wheel skeleton.

In a possible constructional configuration of the invention, the evaluation device and the control device are designed as a joint data processing device. In particular, they are designed as a joint ECU and/or as a joint chip, specifically a microcontroller, or as a joint chip on a joint ECU. By the configuration in the form of a joint data processing device, the monitoring of the skeleton connection can be realized at particularly low cost.

It is particularly preferred that the terminal of the first conductive layer is designed as a first GPIO and/or the terminal of the second conductive layer is designed as a second GPIO in the joint data processing device (GPIO=general purpose input/output). Those interfaces can be implemented at low cost on the chip or are available already in abundance anyway so that the hardware implementation can be realized virtually with no costs involved.

In a preferred product-related implementation, the first layer is designed as a sensor layer for an HOD function (hands-on detection). In particular, the steering wheel arrangement includes a hands-on detection device for implementing the HOD function. The hands-on detection device is particularly in the form of a capacitive hands-on detection device. As already explained, in a capacitive hands-on detection device the definition of the potential on the steering wheel skeleton is particularly important for reliable hands-on detection. The steering wheel arrangement according to the invention can help verify the status of the steering wheel arrangement, in particular the status of the skeleton connection, reliably and, thus, safeguard the HOD function. For example, when assessing the skeleton connection to be not OK, the hands-on detection device can be classified to be defective or inactive.

In a preferred development of the invention, the hands-on detection device is provided to be formed in the joint data processing device, in particular in the joint chip. Said development once again underlines the advantage that the verification of the operability of the skeleton connection can be carried out virtually in a hardware-neutral manner.

Basically, the steering wheel device can be limited to the two conductive layers. In a possible alternative of the invention, the steering wheel device includes at least or exactly one third conductive layer, the third conductive layer being arranged between the second conductive layer and the steering wheel skeleton. The skeleton capacitor then is formed by a single capacitor between the second conductive layer and the third conductive layer as well as by a second single capacitor between the third conductive layer and the steering skeleton. The third conductive layer is preferably designed as a heating layer.

The second conductive layer can be provided to be designed as a heating layer and/or as a guard layer for verifying the operability of the first conductive layer/sensor layer.

Another subject matter relates to a vehicle, the vehicle comprising the steering wheel arrangement. Another subject matter of the invention relates to a method for verifying the skeleton connection by the steering wheel arrangement as described before, wherein the partial voltage is detected at the second conductive layer and, on the basis of the detected partial voltage, the skeleton connection is assessed to be OK or not OK.

Further features, advantages and effects of the invention will result from the following embodiments and the attached figures, wherein:

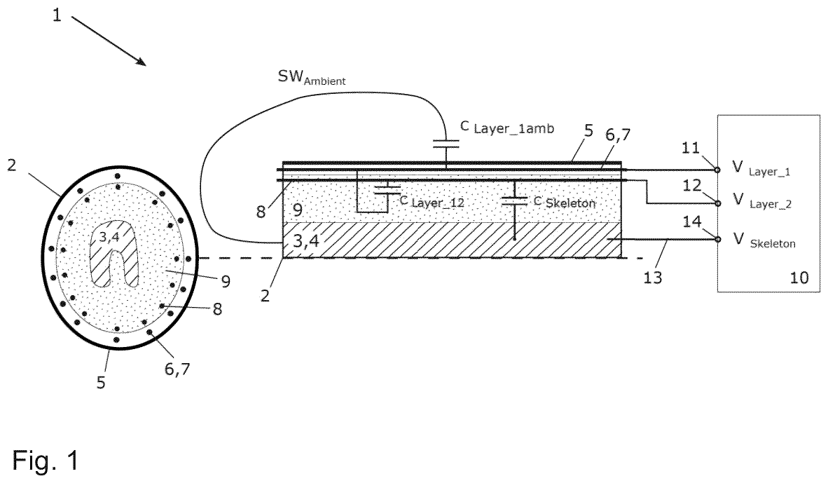

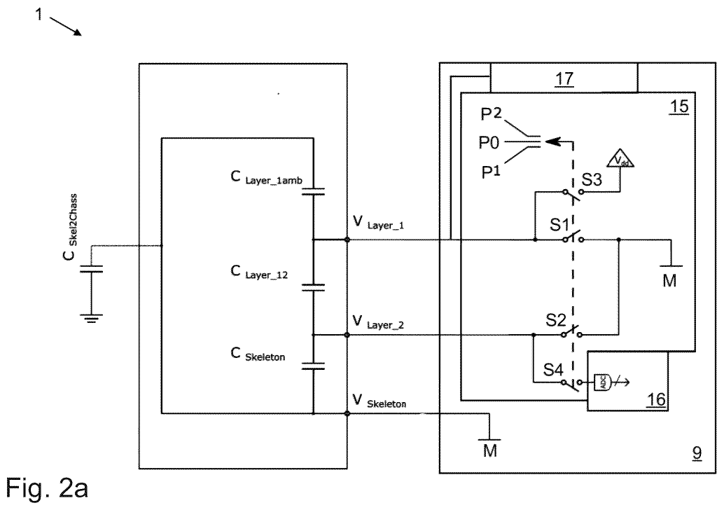

FIG. 1 shows in a schematic representation a steering wheel arrangement as an embodiment of the invention;

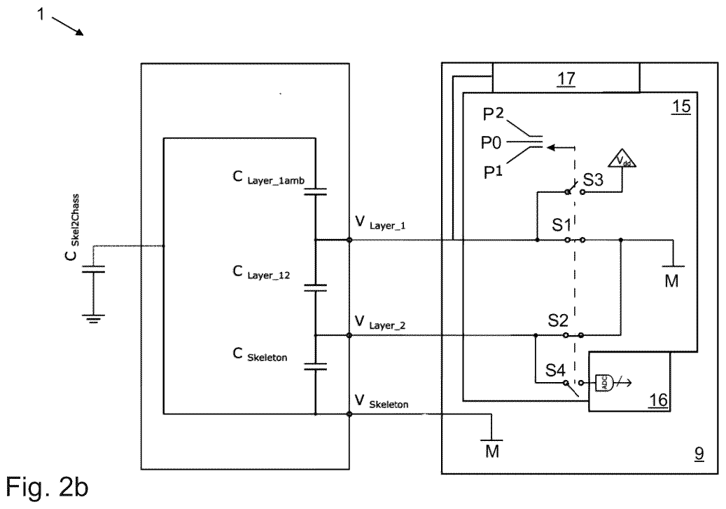

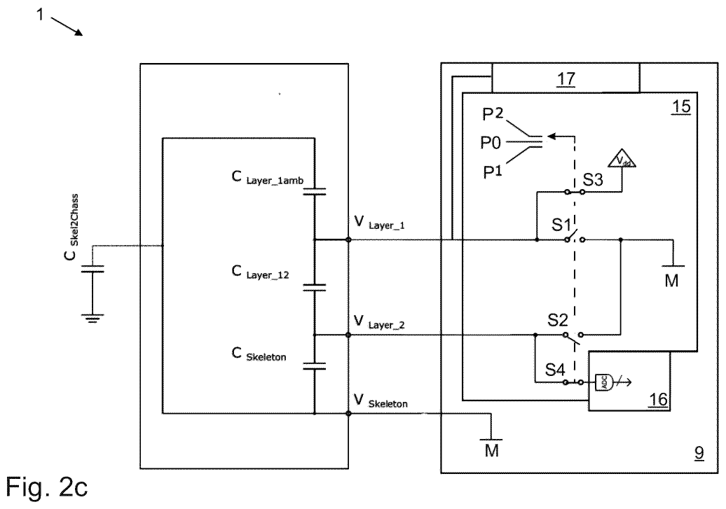

FIGS. 2a, b, c show equivalent circuit diagrams of a first embodiment of the steering wheel arrangement in FIG. 1 in a basic phase, a first phase and a second phase for illustrating the method;

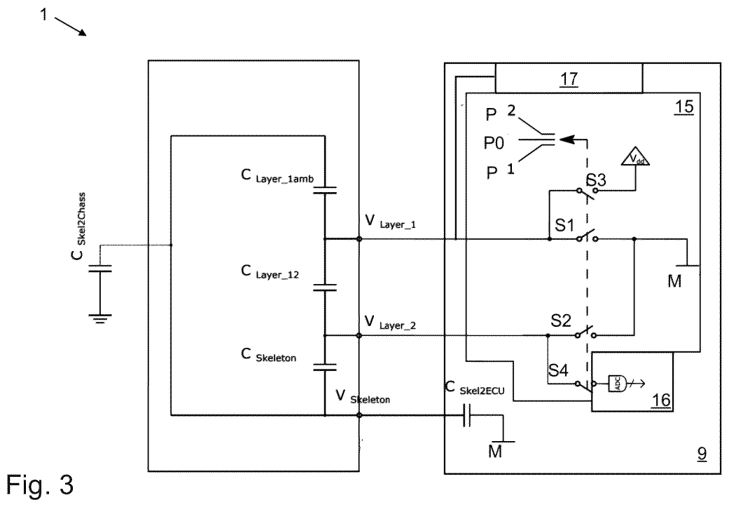

FIG. 3 shows an equivalent circuit diagram of a second embodiment of the steering wheel arrangement in FIG. 1 in a basic phase.

FIG. 1 illustrates a schematic view of a steering wheel arrangement 1 comprising a steering wheel device 2 as an embodiment of the invention. The steering wheel device 2 serves for steering a vehicle (not shown).

The steering wheel device 2 has a steering wheel skeleton 3 including—in this embodiment—a circumferential steering wheel rim 4 (or steering ring) which is schematized with its layers in a longitudinal section. The steering wheel rim 4 can be formed integrally with the steering wheel skeleton 3, alternatively the steering wheel rim 4 and the steering wheel skeleton 3 are two different components which are connected to each other to be electrically conducting, however.

On the steering wheel rim 4, an outer spacing layer 5, such as a leather wrapping or plastic wrapping, is arranged. Adjacent or neighboring thereto, a first conductive layer 6 is provided which optionally forms a sensor layer 7. A second conductive layer 8 is arranged to be separated via an insulating layer. The layer structure abuts on the steering wheel rim 4 and thus on the steering wheel skeleton 3 to be electrically insulated via a foam layer 9. The first conductive layer 6 and the second conductive layer 8 are arranged—as can be seen from the left side of FIG. 1 in a section across the steering wheel device 2—concentrically around the steering wheel rim 4 and, thus, around the steering wheel skeleton 3 in a gripping area for the driver. Other insulating layers can also be used.

It can be seen from the shown cross-section that the first conductive layer 6 and/or the second conductive layer 8 are formed by a conductive wire coiled around the steering wheel rim 4. Hence, the first and/or the second conductive layer(s) 6, 8 form(s) at least one conductive sensor portion.

An inter-layer capacitor C_Layer_12 is formed between the first conductive layer 6 and the second conductive layer 8. A skeleton capacitor C_Skeleton is formed between the second conductive layer 8 and the steering wheel skeleton 3. Optionally, an ambience capacitor C_Layer_1amb can additionally be formed between the steering wheel skeleton 3 and the first conductive layer 6.

The steering wheel arrangement 1 includes a digital data processing device 10 which is realized as an ECU, for example, wherein the first conductive layer 6 is connected to a first terminal 11 of the digital data processing devices 10 so that a voltage V_Layer_1 is present at or provided to the first terminal 11. The second conductive layer 8 is connected via a second terminal 12 of the digital data processing devices 10 so that a voltage V_Layer_2 is present at or provided to the second terminal 12.

The steering wheel skeleton 3, and specifically the steering wheel rim 4, is connected to a third terminal 14 of the digital data processing devices 10 via a skeleton connection 13 so that a voltage V_Skeleton is present at the third terminal 14. The third terminal 14 is or can be connected to an earth of the vehicle so that the steering wheel skeleton 3 is coupled to the earth via the skeleton connection 13. Alternatively, the skeleton connection 13 is and/or can be coupled to the earth without the digital data processing device 10. The skeleton connection 13 is designed as a cable, for example.

Each of the FIGS. 2a, b, c shows an equivalent circuit diagram of the steering wheel arrangement 1 in FIG. 1, equal components being provided with equal reference signs or designations. In addition, a vehicle capacitor C_Skel2chass is inserted which describes the capacitance between the vehicle and the steering wheel skeleton 3. Preferably, a galvanic separation from the earth of the vehicle is provided.

In the digital data processing device 10, four switches S1 . . . S4 are plotted, wherein the switch S1 connects the first conductive layer 6 and the switch S2 connects the second conductive layer 8 to an earth M. The switch S3 connects the first conductive layer 6 to a d.c. voltage Vdd, for example to a supply voltage, the switch S4 connects the second conductive layer to an analog-digital converter ADC. To connect means that the respective switch in a closed state establishes a conducting connection and in an opened state the conducting connection is opened. The switches S1 . . . S4 are particularly used to display the function and can also be designed as dual switches, changeover switches etc.

FIG. 2a illustrates a possible basic phase P0, where all switches S1 . . . S4 are opened. The basic phase need not absolutely be assumed.

In the basic phase P0, all switches S1 . . . S4 are opened so that the first conductive layer 6 and the second conductive layer 8 are connected to be electrically insulated in the digital data processing device 10. The basic phase P0 does not necessarily have to be taken, but constitutes an option.

FIG. 2b illustrates a first phase P1, wherein the switches S1 and S2 are closed and the switches S3 and S4 are opened. The first conductive layer 6 and the second conductive layer 8 are connected to the earth M of the digital data processing device 10. The skeleton connection 13 is connected to the same earth M in the digital data processing device 10.

Optionally, the earth M of the digital data processing device 10 is conductively connected to an earth of the vehicle. In the first phase P1, thus the first conductive layer 6 and the second conductive layer 8 are brought to a first voltage state common in this case, i.e. the earth M.

FIG. 2c illustrates a second phase P2, wherein the switches S1 and S2 are opened. After opening the switches S1 and S2, the switches S3 and S4 are closed. Thus, the d.c. voltage Vdd, for example 5 V, is present at the first layer 6. The second conductive layer 8, on the other hand, is set to high impedance and is connected to the analog-digital converter ACD.

A partial voltage adjusts by the change from the first phase P1 to the second phase P2 in the capacitive divider which is formed by the inter-layer capacitor C_Layer_12 and the skeleton capacitor C_Skeleton at the center tap formed by the second conductive layer 8. Said partial voltage is measured by the analog-digital converter ADC.

In case that the skeleton connection 12 is OK, a reference value for said partial voltage is resulting. Said reference value is stored in the digital data processing device 10. In case that the skeleton connection 13 is defective, i.e. is not OK, a value deviating therefrom is resulting for the partial voltage. The skeleton connection 13 designed as a cable is not OK, for example, if the cable is interrupted or not connected. Consequently, by comparing the partial voltage in the second phase P2 to the reference value established before, a defect in the skeleton connection 13 can be safely concluded.

The digital data processing device 10 comprises, from the functional perspective, a control device 15 which controls the activation of the switches S1 . . . S4. Further, the digital data processing device 10 includes an evaluation device 16, wherein the evaluation device 16 takes over the measurement of the partial voltage by the analog-digital converter ADC and carries out an assessment by comparing to the reference value whether the skeleton connection 13 is OK or not OK. Optionally, the digital data processing device 10 includes a hands-on detection device 17, the hands-on detection device 17 using the first layer 6 as the sensor layer 7 and via a capacitive measurement establishing whether the driver's hand is placed on the steering wheel device 2, particularly on the steering wheel rim 4, specifically in the gripping area of the steering wheel rim 4, or whether the driver does not touch the steering device 2 and, resp., the steering wheel rim 4. For example, the assessment of the evaluation device 16 can be forwarded to the hands-on detection devices 17, wherein, in case that the skeleton connection 13 is assessed to be not OK, the hands-on detection device 17 is classified to be not ready-for-use and/or, for example, an error message is displayed to the driver via an optical signal device (not shown).

Each of the first terminal 11 and the second terminal 12 can be designed as a GPIO (general purpose input/output), wherein the functions of connecting to the earth M of the digital data processing device 10, the connection to the d.c. voltage Vdd and/or the connection to the analog-digital converter ADC are realized, in terms of circuitry, by the GPIOs. Those GPIOs either are already provided anyway in common chips, particularly microcontrollers, or can be implemented at very low cost so that the monitoring of the skeleton connection 13 can be implemented with virtually no hardware and thus no costs involved. In particular, the digital data processing device 10 is designed as a microcontroller with the GPIOs.

FIG. 3 illustrates an equivalent circuit diagram of the steering wheel arrangement 1 in FIG. 1 in a modified embodiment, the skeleton connection 13 being connected to the earth of the digital data processing device 10 and/or the earth of the vehicle via a connection capacitor C_Sekl2ECU.

In the following, there is illustrated a model calculation as to how the difference between the reference value of the partial voltage and the partial voltage in a skeleton connection 13 which is not OK is calculated:

### Phase P1:

In the first phase P1, VLayer_1 and VLayer_2 is set to zero voltage against ECU Ground (earth M).
Phase P2 with an Intact Skeleton Connection 13:

In phase 2, initially VLayer_1 and VLayer_2 are separated from ECU Ground (earth M). Then VLayer_1 is connected to the d.c. voltage VDD of the ECU, viz. the digital data processing device 10, and after short charging at VLayer_2 the following partial voltage will occur which forms the reference value:

$${V}_{Layer \_ 2} = {V}_{DD} \frac{{C}_{Layer \_ 12}}{{C}_{Skeleton} + {C}_{Layer \_ 12}}$$

Phase 2 with an Interrupted Skeleton Connection 13:

If the connection from the steering wheel skeleton 3 to ECU Gnd (earth) is interrupted, in phase P2 a voltage different from 0 (earth M) occurs after reloading on the steering wheel skeleton side of the interrupted skeleton connection 13:

$${V}_{{Skleleton}_{broke}} = {V}_{DD} \frac{{C}_{{Layer}_{1 amb}} + ( {C}_{{Layer}_{12}} ‖ {C}_{Skleton} )}{{C}_{Skel 2 Chass} + {C}_{{Layer}_{1 amb}} + ( {C}_{{Layer}_{12}} ‖ {C}_{Skleton} )}$$

$$with {C}_{Layer \_ 12} ‖ {C}_{Skleton} = \frac{{C}_{Layer \_ 12} * {C}_{Skleton}}{{C}_{Layer \_ 12} + {C}_{Skleton}}$$

For the measured partial voltage at the second conductive layer 8, the following results for the interrupted skeleton connection 13:

$${V}_{Layer \_ 2} = ( {V}_{DD} - {V}_{Skleleton \_ broke} ) \frac{{C}_{Layer \_ 12}}{{C}_{Skeleton} + {C}_{Layer \_ 12}}$$

$${Δ V}_{Layer \_ 2} = ( {V}_{DD} - {V}_{{Skleleton}_{broke}} ) \frac{{C}_{{Layer}_{12}}}{{C}_{Skeleton} + {C}_{{Layer}_{12}}} - {V}_{DD} \frac{{C}_{{Layer}_{12}}}{{C}_{Skeleton} + {C}_{{Layer}_{12}}} = - {V}_{Skleleton \_ broke} \frac{{C}_{Layer \_ 12}}{{C}_{Skeleton} + {C}_{Layer \_ 12}}$$

$${Δ V}_{Layer \_ 2} = - {V}_{DD} \frac{1}{1 + \frac{{C}_{Skel 2 Chass}}{{C}_{Layer \_ 1 amb} + ( {C}_{Layer \_ 12} ‖ {C}_{Skleton} )}} \frac{{C}_{Layer \_ 12}}{{C}_{Skeleton} + {C}_{Layer \_ 12}}$$

For typical steering wheel applications as in FIG. 1, the following can be assumed due to geometric facts:

### Geometric Boundary Condition 1:

$${C}_{Skel 2 Chass} < {C}_{Layer \_ 1 amb} < {C}_{Layer \_ 12} und {C}_{Skeleton}$$

### Geometric Boundary Condition 2:

$$\frac{1}{3} {C}_{Skeleton} < {C}_{Layer \_ 12} < 3 {C}_{Skeleton}$$

For steering wheel applications, the following results therefrom:

$$\frac{5}{36} {V}_{DD} < {Δ V}_{Layer \_ 2} < \frac{21}{44} {V}_{DD}$$

That is to say that in all standard steering wheel configurations, the interrupted skeleton connection 13 to the steering wheel skeleton 3 can be safely measured, as it amounts at least to a voltage difference of 5/36 V_DD at the second terminal 12 of the second conductive layer 8/Layer_2.

### Example

In a 10 bit analog-digital converter ADC, the loss of the skeleton connection results at least in a difference of 5/36*1023 bit=142 bit in the sampling of VLayer_2.

In the following table, various possible applications of the skeleton diagnosis are listed. In this context, it is noted that for the layers which the HOD and the heating function share with the skeleton diagnosis, the two functions cannot be carried out simultaneously. Each of HOD and skeleton diagnosis thus requires a separate time window in which the function is carried out. In the three-layer system, the heating can be carried out simultaneously with the skeleton diagnosis. The condition for this is that the second electric layer has a capacitive access to the steering wheel skeleton 3. This is always the case when the heating layer does not form a closed sphere around the steering wheel skeleton 3. In the evaluation, merely shift transients of the heating then have to be observed which can be excluded by multiple sampling.

TABLE
Possible applications of the skeleton diagnosis
in various steering wheel configurations

| | Function of the electrically conducting layers in the | | | | |
|---|---|---|---|---|---|
| | steering wheel | | | | |
| | | | Two- | Two- | Three- |
| Steering | Skeleton | Two- | layer | layer | layer |
| wheel | broken | layer | HOD/ | HOD/ | HOD/ |
| structure | diagnosis | HOD | heating | heating | heating |
| First | Layer 1 | HOD | HOD | HOD | HOD |
| celectrically | | sensor | sensor | sensor | sensor |
| onducting | | | | | |
| layer 6 | | | | | |
| Second | Layer 2 | HOD | Heating | Heating/ | HOD |
| electrically | | auxiliary | | HOD | auxiliary |
| conducting | | layer | | auxiliary | layer |
| layer 8 | | (guard) | | layer | (guard) |
| | | | | (guard) | |
| Third | | — | — | — | Heating |
| electrically | | | | | |
| conducting | | | | | |
| layer | | | | | |
| Steering | Skeleton | Skeleton | Skeleton | Skeleton | Skeleton |
| wheel | | | | | |
| skeleton | | | | | |

### Galvanic Separation in the Skeleton Connection 13 According to FIG. 3:

If the connection to the steering wheel skeleton 13 is carried out via the capacitor CSkIe2ECU (FIG. 3), the preceding formulae are applicable with a small deviation as soon as the capacitance is by far larger (>tenfold) than the other capacitances involved. The diagnosis of the loss of the skeleton connection 13 thus works safely even with a capacitive connection.

### REFERENCE SIGNS

1 steering wheel arrangement
2 steering wheel device
3 steering wheel skeleton
4 steering wheel rim
outer spacing layer
6 first conductive layer
7 sensor layer
8 second conductive layer
9 foam layer
10 digital data processing device
11 first terminal of the digital data processing device
12 second terminal of the digital data processing device
13 skeleton connection
14 third terminal of the digital processing device
15 control device
16 evaluation device
17 hands-on detection device
P0 basic phase
P1 first phase
P2 second phase
S1 . . . S4 switches
C_Layer_12 inter-layer capacitor
C_Skeleton skeleton capacitor
C_Layer_1amb ambience capacitor
C_Skel2chass vehicle capacitor
C_Sekl2ECU connection capacitor
M earth

1. A steering wheel arrangement for a vehicle, comprising a steering wheel device, wherein the steering wheel device has
a steering wheel skeleton
a first conductive layer, and
a second conductive layer,
wherein an inter-layer capacitor (C_Layer_12) is formed between the first conductive layer and the second conductive layer,
wherein a skeleton capacitor (C_Skeleton) is formed between the second conductive layer and the steering wheel skeleton,
wherein the steering wheel skeleton can be and/or is coupled to an earth (M) of the vehicle,
wherein the inter-layer capacitor (C_Layer_12) and the skeleton capacitor (C_Skeleton) form a capacitive voltage divider for a voltage present at the first conductive layer, wherein a partial voltage can be sensed at the second conductive layer,
wherein an evaluation device, wherein the evaluation device is designed to detect the partial voltage at the second conductive layer and, on the basis of the detected partial voltage, to assess the skeleton connection to be OK or not OK.

2. The steering wheel arrangement according to claim 1, wherein a control device, wherein the control device is designed to bring, in a first phase (P1), each of the first conductive layer and the second conductive layer into a defined and/or joint first voltage state, and, in a second phase (P2), to decouple the second conductive layer and to bring the first conductive layer into a second voltage state, the evaluation device being designed to measure the partial voltage in the second phase (P2).

3. The steering wheel arrangement according to claim 2, wherein the first voltage state corresponds to an earth (M) and the second voltage state corresponds to a d.c. voltage (VDD).

4. The steering wheel arrangement according to claim 1, wherein an ambience capacitor (C_Layer_1amb) is formed between the first conductive layer (6) and the steering wheel skeleton (3).

5. The steering wheel arrangement according to claim 1, wherein the evaluation device and the control device are designed as a joint data processing device.

6. The steering wheel arrangement according to claim 1, wherein the terminal of the first conductive layer is designed as a first GPIO and/or the second terminal is designed at the second conductive layer as a second GPIO.

7. The steering wheel arrangement according to claim 1, wherein the first layer is designed as a sensor layer for an HOD detection and in that the steering wheel arrangement has a hands-on detection device.

8. The steering wheel arrangement according to claim 7, wherein the hands-on detection device is designed in the joint data processing device.

9. The steering wheel arrangement according to claim 1, wherein a third layer, wherein the third layer is arranged between the second conductive layer and the steering wheel skeleton, wherein the skeleton capacitor (C_Skeleton) is formed by a first single capacitor between the second conductive layer and the third conductive layer and a second single capacitor between the third conductive layer and the steering wheel skeleton.

10. A vehicle comprising a steering wheel arrangement according to claim 1.

11. A method for verifying the skeleton connection in a steering wheel arrangement according to claim 1, wherein the partial voltage is detected at the second conductive layer and, on the basis of the detected partial voltage, the skeleton connection is assessed to be OK or not OK.

12. The method according to claim 11, wherein in a first phase (P1) each of the first conductive layer and the second conductive layer is brought into a defined first voltage state, and in a second phase (P2) the second conductive layer is decoupled and the first conductive layer is brought into a second voltage state, wherein the second voltage state is designed differently from the first voltage state, and then the partial voltage is measured in the second phase.
